(19) United States
(12) Patent Application Publication
(10) Pub. No.: US 2011/0205668 A1
(43) Pub. Date: Aug. 25, 2011

(54) MAGNETIC RECORDING MEDIUM AND MANUFACTURING METHOD THEREOF

(75) Inventor: Shinji UCHIDA, Matsumoto (JP)

(73) Assignee: Fuji Electric Device Technology Co., Ltd., Tokyo (JP)

(21) Appl. No.: 12/964,413

(22) Filed: Dec. 9, 2010

(30) Foreign Application Priority Data
Feb. 24, 2010 (JP) 2010-038815

(51) Int. Cl. G11B 5/82; G11B 5/84; C23F 1/02

(52) U.S. Cl. 360/135; 427/548; 216/22; G9B/5.293

(57) ABSTRACT

A magnetic recording medium comprises a data region for recording data and a servo region that is disposed adjacent to the data region and has recorded information for controlling a magnetic head. The data region has a pattern of dots separated from each other by grooves or nonmagnetic material. The servo region lacks the pattern of dots, and includes magnetic information written in a flat region. The magnetic recording medium can be formed by a method that does not need a separate process of writing servo information.

### CROSS-REFERENCE TO RELATED APPLICATION

This application claims priority under 35 U.S.C. §119 from Japanese Patent Application No. 2010-038815, filed on Feb. 24, 2010, the entirety of which is incorporated herein by reference.

### BACKGROUND OF THE INVENTION

1. Field of the Invention

The present invention relates to a magnetic recording medium, in particular to a magnetic recording medium that does not need any separate process of writing servo information. The present invention also relates to a method of manufacturing a magnetic recording medium to which servo information is readily recorded.

2. Description of the Related Art

Hard disk drives (HDDs) are used for a type of information storage devices in a highly advanced information society. With growth of information in recent years, magnetic recording media used in a fixed magnetic storage device (an HDD) are required to enhance the recording density. In order to attain high recording density, a magnetization inversion unit (a recording unit) needs to be minimized, which can be achieved by miniaturization of magnetic particles. Considering magnetic interaction between the recording units, it is important to distinctly isolate the recording units from each other as well as to minimize magnetic particles.

Perpendicular magnetic recording media have provided relatively high quality in magnetic characteristics and electromagnetic conversion characteristics until recent days. A perpendicular magnetic medium has conventionally had a configuration of a continuous film as seen from a planar direction. Further higher recording density needs to achieve: prevention of blur to an adjacent track, decrease of zigzag magnetic domain walls formed with randomly arranged particles, suppression of thermal fluctuation caused by miniaturization of crystal grains, and reduction of magnetic interaction between magnetic particles.

Accordingly, a discrete track medium has been proposed. This medium has a line of magnetic material with recording units distinctly isolated, which is a line of magnetic material with magnetic isolation between tracks, obtaining a boundary between adjacent tracks artificially. This medium avoids blur to the next track and prevents the zigzag magnetic domain walls from being formed.

A patterned medium is attracting attention as well. Japanese Unexamined Patent Application Publication No. H10-233015, for example, discloses a type of specific patterned medium in which isolated dots of single magnetic domains having artificially unified shape and/or dimensions are arranged in an array. Reading and writing are executed on recording bits, each single bit corresponding to a single dot of magnetic material.

Some technologies are known for forming an isolation structure of magnetic materials in a patterned medium. However, they have both merit and drawbacks, demanding some improvement. A photolithography method, for example, has a merit in the throughput owing to the exposure in a lump, on the one hand, although unsuited to batch exposure on a large area of a magnetic recording medium with a fine pattern in a feature size of 10 to 20 nm, on the other hand. An electron beam lithography method and a focused ion beam lithography method irradiate the medium with an electron beam or a focused ion beam tracing along a pattern. Consequently, although these methods allow the fine pattern of feature size of 10 to 20 nm to be formed, it takes several days for working throughout such a large area as of a magnetic recording medium. Thus, these methods are impractical in view of working cost due to long working time.

In order to overcome the drawbacks in the conventional technologies, methods utilizing self assembly have been proposed. Japanese Unexamined Patent Application Publication No. H10-320772, for example, discloses a method of manufacturing a magnetic recording medium, in which fine particles having a diameter in the range of several nm to several μm are two dimensionally arranged on a substrate and the particles are used as a mask for patterning, to provide isolated fine magnetic particles on the substrate.

One non-patent document, referenced herein as P. Mansky et al, Appl. Phys. Lett., vol. 68, p. 2586 (1996), and another non-patent document, referenced herein as M. Park et al, Science, vol. 276, p. 1401 (1997), for example, disclose a method of forming a pattern using a self assembled phase separation structure of a block copolymer. The method using a block copolymer can form a pattern with an ordered arrangement by a very simple process of just dissolving the block copolymer in an appropriate solvent and applying it on a working article. The phase separation structure of a block copolymer is generally generated by self assembly in a honeycomb structure with a hexagonal closest packed lattice structure.

Japanese Unexamined Patent Application Publication No. 2002-175621 discloses a magnetic recording medium in which magnetic metal is filled in alumina pores utilizing a self assembled array structure of anodized alumina pores.

A fine arrangement can be formed on a large area at a low cost utilizing the arrangement of fine particles, the self assembly of block copolymer, and the self assembly of anodized alumina. The arrangement by these methods has an ordered structure in two dimensional planes within a relatively short range over 10 to 20 particles. However, the arrangement is not ordered in a long range but exhibits a polycrystalline structure. Consequently, a magnetic recording medium as a whole may have a multiple of defects.

Some other methods have been proposed to solve this problem and ensure an ordered structure over whole surface of a magnetic recording medium. Japanese Unexamined Patent Application Publication No. 2006-346820, for example, discloses a method comprising steps of forming a line of protrusions and recesses on a base material, arranging fine particles on the line of protrusions and recesses into a monolayer in a pattern, transferring the arrangement pattern of the fine particles to a stamper-forming material to produce a stamper, forming seed points for generating nano-holes on a metal base material using the stamper, and forming nano-holes on the metal base material. Japanese Unexamined Patent Application Publication No. 2002-334414 discloses a recording medium manufactured by a method utilizing a self assembly of a block copolymer. This recording medium has a structure composed of an array of a plurality of cells formed on a disk substrate, each cell containing particles of magnetic material arranged in an ordered lattice, and having a shape of a parallelogram enclosed by two approximately parallel straight lines in the circumferential direction of the track and two other approximately parallel straight lines intersecting with these circumferential straight lines at an angle of 60 degrees or 120 degrees.

As described above, a multiplicity of methods for enhancing recording density have been proposed by composing a fine pattern of recording units for magnetic recording. In order to effectively carry out actual read-write operations in an HDD, it is not sufficient to simply miniaturize the recording unit.

An HDD performs reading and writing of data by a magnetic head flying at a height of about 10 nm over a magnetic recording medium. Bit information on the magnetic recording medium is stored on data tracks arranged concentrically on the medium. The magnetic head is positioned on the data track in the process of reading and writing of data. Servo information for positioning the magnetic head is also recorded on the magnetic recording medium. FIG. 3 is a plan view of a magnetic recording medium 10. The medium 10 includes a region of data tracks 32 and a region of servo tracks 34 that is adjoining to the region of data tracks 32 and contains servo information recorded thereon. The data track 32 and the servo track 34 are alternately disposed in the circumferential direction of the medium. The servo information is generally recorded using a magnetic head. As a result, writing time is increasing with the growing number of recording tracks in recent years, which raises a problem of decrease in productivity of HDDs.

Recently, a method of recording the entire servo information altogether at once on a magnetic recording medium by means of magnetic transfer technology has been proposed using a master disk carrying the servo information instead of writing the servo information using a magnetic head. Japanese Unexamined Patent Application Publication No. 2002-083421, for example, discloses a method of transferring servo information of a master disk to a perpendicular recording medium using a master disk having a servo pattern formed with a ferromagnetic material.

In the conventionally proposed patterned media, a data region and a servo region are simultaneously formed and composed of dots separated with grooves or nonmagnetic material parts. However, for the following reason, it has been made clear that the servo pattern in a patterned medium is difficult to produce by a simultaneous nano imprinting process as described.

A data region comprises a data recording parts of magnetic material and separating parts of grooves or nonmagnetic material parts. The data recording parts separated with the grooves or nonmagnetic material parts are formed with a constant gap. Consequently, an aerial percentage (a duty ratio) of protruding parts of the resist in the imprinting process is unchanged. The servo region, on the other hand, comprises a preamble section, a burst section, and an address section. The duty ratios in these sections are different, and thus, the servo region as a whole includes a mixture of different duty ratio portions.

The mixture of different duty ratios in an imprinting process results in varied pattern height, that is, different thickness of remained resist films at the recessed parts. The reason for this is described below. The remained film is generated because the volume of the applied resist is larger than the volume of the space in the recessed part of the pattern. When the application thickness is large, the remained film is relatively thin at the part of small duty ratio and the remained film is relatively thick at the part of large duty ratio. The varied thickness of the remained films hinders a uniform processing of removing the remained films by etching. For obtaining a unified thickness of the remained films, a thickness of applying resist needs to be thin corresponding to the parts of small duty ratio. In the parts with a large duty ratio, however, the pattern height becomes low, raising a possibility of degrading magnetic characteristics that must be preserved.

Accordingly, Japanese Unexamined Patent Application Publication No. 2007-095116 discloses use of a stamper with different depth of recessed parts corresponding to the proportion of protruding parts and recessed parts. However, it is not an easy task to fabricate a stamper with suitably varied depths of fine grooves.

It may be considered to level the duty ratio by providing a dummy pattern. That is however not a satisfactory resolution because deviation within a microscopic region in the duty ratio remains. To cope with this problem, a study is conducted forming the data region and a servo region with different duty ratios in separate processes. If solely a data region is formed in a patterned medium, a servo region must be formed thereafter. However, in the process of magnetic recording with the magnetic head, it is difficult to control the magnetic head in using the pattern on the data region that has been formed preliminarily. Therefore, the servo region may not be written sufficiently. Further, it is difficult to transfer a pattern of the servo region with a positioning accuracy of nanometer figures matching with a pattern of the preliminarily formed data region. Therefore, good writing in the servo region may not be performed.

Although various types of magnetic recording media and technologies relating to the media have been disclosed as mentioned above, there exists a demand for a magnetic recording medium that does not need a separate process of writing servo information. There also exists a demand for a method for manufacturing a magnetic recording medium which allows easy recording of the servo information to obtain such a magnetic recording medium.

### SUMMARY OF THE INVENTION

It is therefore an object of the present invention to provide a magnetic recording medium that does not need a separate process of writing servo information. Another object of the present invention is to provide a method of manufacturing a magnetic recording medium allowing easy recording of the servo information in the procedure to obtain such a magnetic recording medium.

A magnetic recording medium according to the present invention comprises a data region for recording data and a servo region that is disposed adjacent to the data region and has recorded information for controlling a magnetic head, the data region having a pattern of dots separated by grooves or nonmagnetic material from each other, and the servo region lacking the pattern of dots and including magnetic information written in a flat region. Magnetic recording media of the present invention are used in a variety of information recording devices.

A method of manufacturing a magnetic recording medium according to the present invention comprises steps of: forming a resist layer at least in a region to form a data region of a magnetic recording layer formed on a nonmagnetic substrate; forming a pattern of resist by pressing the resist layer by a stamper having a fine pattern of protrusions and recesses formed thereon; and applying a magnetic field in a thickness direction of the magnetic recording layer while maintaining an adhered state of the resist layer and the stamper to transfer magnetic information according to the pattern of protrusions and recesses on the stamper to the magnetic recording layer.

Preferably, the method of manufacturing a magnetic recording medium according to the invention further comprises steps of: forming a resist layer in a region to form the servo region on the magnetic recording layer; forming a plurality of grooves or a plurality of nonmagnetized regions in the region to form the data region of the magnetic recording layer to form a pattern of dots separated by the grooves or the nonmagnetized regions; and removing the resist layer remained in the data region and the servo region.

Preferably, the method of manufacturing a magnetic recording medium according to the invention further comprises a step of forming an underlayer between the nonmagnetic substrate and the magnetic recording layer.

The servo information has been recorded in the servo region in a magnetic recording medium according to the present invention. Therefore, it is unnecessary to write servo information in a separate later step.

A method of manufacturing a magnetic recording medium according to the present invention performs pattern formation in the data region and the servo region using a single stamper in specified steps. Therefore, servo information in particular can be readily recorded.

Because the manufacturing method of the invention performs pattern formation in both the data region and the servo region using a single stamper in specified steps, any mismatching at a boundary between the data region and the servo region is avoided. Therefore, in a writing process to the data region of the magnetic recording medium, positioning of the magnetic head is performed favorably accommodating the designated data region owing to the servo information recorded on the servo region.

### BRIEF DESCRIPTION OF THE DRAWINGS

FIG. 1 is a perspective view of a magnetic recording medium according to the present invention, partly showing a data region and a servo region;

FIGS. 2A through 2F are sectional views sequentially showing a method, according to the present invention, of manufacturing a magnetic recording medium,

FIG. 2A showing a step of forming a resist layer on a region to form a data region,

FIG. 2B showing a step of pressing the resist layer by a stamper, FIG. 2C showing a step of applying a magnetic field in the state of close adhesion with the stamper,

FIG. 2D showing a step of forming a resist layer on a region to form a servo region,

FIG. 2E showing a step of etching, and FIG. 2F showing a step of removing the resist layer and other layers; and

FIG. 3 is a plan view of a magnetic recording medium of a general configuration, in which the blank (without hatching) regions show data regions and the hatched region show servo regions.

### DETAILED DESCRIPTION OF THE INVENTION

Various non-limiting embodiments of the invention will now be described in more detail with reference to the accompanying figures. It should be kept in mind that the following described embodiments are only presented by way of example and should not be construed as limiting the inventive concept to any particular physical configuration.

<1. Magnetic Recording Medium>

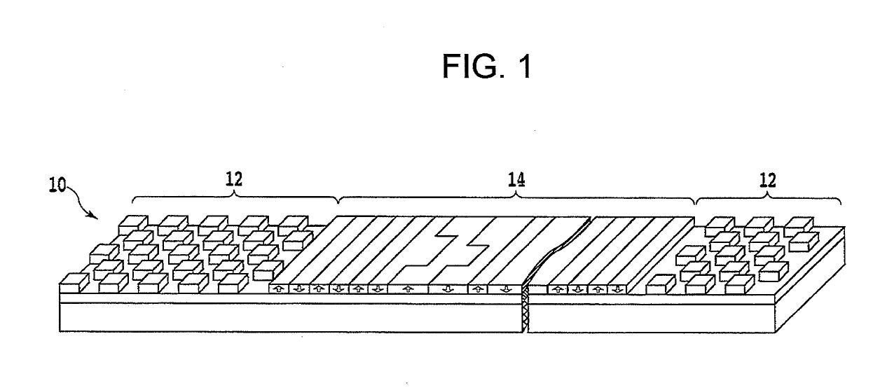

FIG. 1 is a perspective view of a magnetic recording medium 10 according to the present invention partly showing a data region 12 and a servo region 14. Referring to FIG. 1, the magnetic recording medium 10 comprises a data region 12 for recording data and a servo region 14 adjoining the data region 12 and including control information for a magnetic head recorded thereon.

Although the magnetic recording medium 10 as shown in FIG. 1 shows only two data regions 12 and one servo region 14, the magnetic recording medium as a whole actually includes a large number of data regions 12 and servo regions 14 alternately arranged.

The data region 12 has a pattern consisting of or including protruding dots separated by grooves or nonmagnetic material. (FIG. 1 shows a case of separation by grooves.)

Unlike the data region 12, the servo region 14 does not have a pattern that is formed of dots. The servo region 14 as a whole forms a flat region divided into a plurality of sections, in which magnetic information consisting of or including N/S (e.g., north/south polarities) is recorded in the vertical direction in FIG. 1.

A magnetic recording medium according to the present invention has a construction as described above, in which servo information has already been formed in the servo region, as well as a pattern in the data region. Therefore, servo information does not need to be written any more in a separate process afterwards.

<2. A Method of Manufacturing a Magnetic Recording Medium>

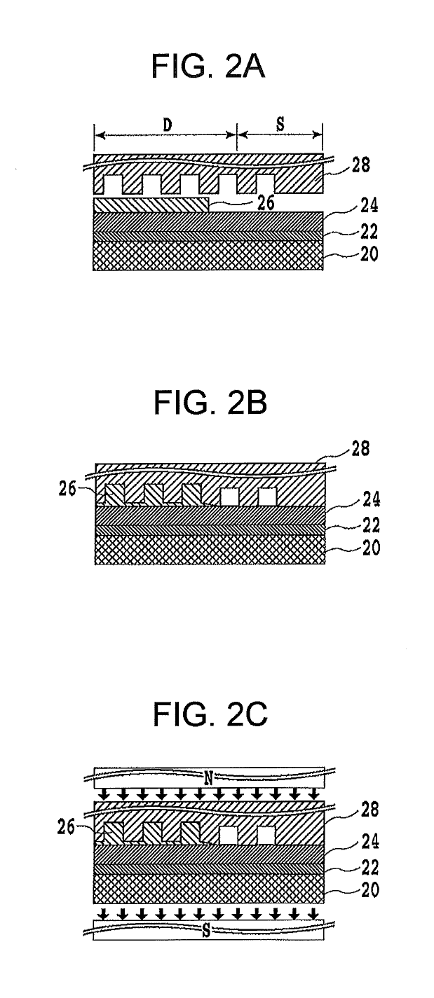

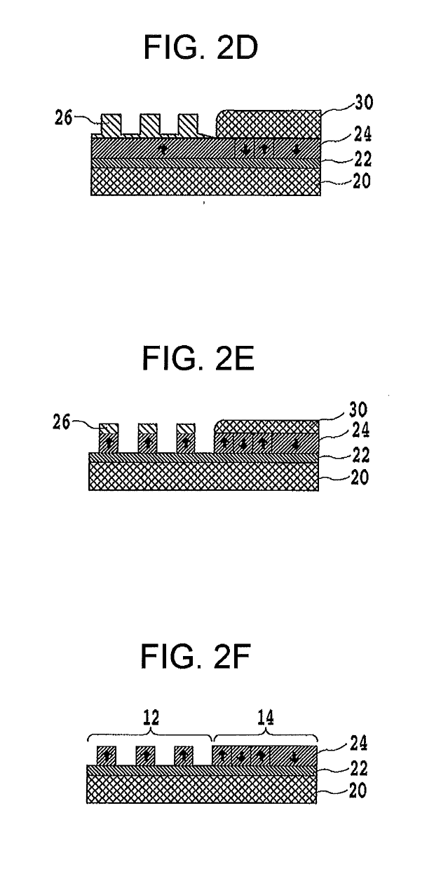

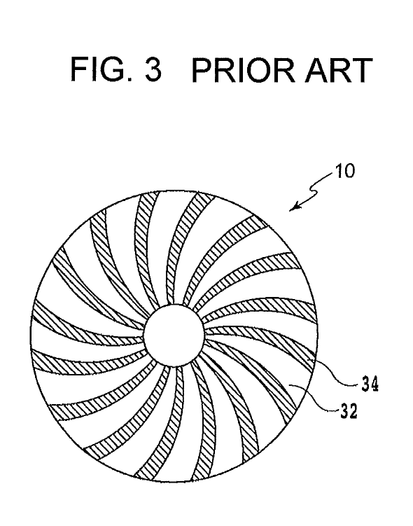

FIGS. 2A through 2F are sectional views sequentially showing a method, according to the present invention, of manufacturing a magnetic recording medium. The following describes in detail the steps of: (a) forming a resist layer on a region to form a data region, (b) pressing the resist layer by a stamper, (c) applying a magnetic field in the state of close contact with the stamper, (d) forming a resist layer on a region to form a servo region, (e) etching, and (f) removing the resist layer.

In some cases in the following description, a region to form a data region is referred to as a region D and a region to form a servo region is referred to as a region S as indicated in FIG. 2A. The symbols D and S indicated in FIG. 2A are commonly applicable to all FIGS. 2A through 2E and correspond to the data region 12 and the servo region 14 in FIG. 2F, respectively, of the magnetic recording medium.

[2-1. Step (a) of Forming a Resist Layer on the Data Region]

(2-1-1. Process of Forming a Laminated Body and Applying a Resist Material)

FIG. 2A is a sectional view showing a step of forming a resist layer in the region D on a magnetic recording layer. Referring to FIG. 2A, an underlayer 22, a magnetic recording layer 24, and if necessary, a mask layer, which is not shown in the figure, are formed on a nonmagnetic substrate 20. After sequentially forming these layers, a resist material 26 is applied on the region D. Separately from the processes of forming these layers, a stamper 28 is prepared.

A material to be employed for the nonmagnetic substrate 20 can be selected from the ones commonly used for magnetic recording media. The materials include, for example, NiP-plated aluminum alloy, strengthened glass, and crystallized glass. Dimensions of the nonmagnetic substrate 20 can be, in consideration of conventionally employed substrate sizes, an outer diameter of 48 to 95 mm, an inner diameter of 12 to 25 mm, and a thickness of 0.5 to 1.3 mm.

The underlayer 22 can comprise a soft magnetic backing layer and a crystal orientation control layer. The underlayer 22 can be omitted.

The soft magnetic backing layer is formed for controlling a magnetic flux from a magnetic head used for magnetic recording and for improving reading and writing characteristics. Useful materials for the soft magnetic backing layer include amorphous cobalt alloys of CoZrNb and CoTaZr.

The crystal orientation control layer is formed for controlling the crystal orientation and the grain size of the magnetic recording layer. The crystal orientation control layer can be composed of a soft magnetic material or a nonmagnetic material. The soft magnetic material is preferable because the material performs a part of the function of a soft magnetic backing layer. The soft magnetic material can be selected from permalloy materials of NiFeAl, NiFeSi, NiFeNb, NiFeB, NiFeNbB, NiFeMo, and NiFeCr. The nonmagnetic material for use in the crystal orientation control layer can be selected from Ta, Zr, and Ni3Al. The nonmagnetic material can also be selected from ruthenium and ruthenium alloys containing at least one alloying element selected from the group consisting of C, Cu, W, Mo, Cr, Ir, Pt, Re, Rh, Ta, and V. Pt, Ir, Re, and Rh can be used as well. These materials are preferable from the view point of a crystal structure with a fine uniform grain size having an axis of easy magnetization of the magnetic recording layer aligning perpendicularly to the film surface, which is suited to high density recording.

The magnetic recording layer 24 is preferably formed of a ferromagnetic alloy containing at least cobalt and platinum. An axis of easy magnetization of the material (for example, the c-axis of a hexagonal closest packed crystal structure) needs to orient perpendicularly to the film surface in order to be used in a perpendicular magnetic recording medium. Useful materials for the magnetic recording layer 24 include alloys of CoPt, CoCrPt, CoCrPtB, and CoCrPtTa. A thickness of the magnetic recording layer 24 is preferably in the range of 1 to 100 nm from the view points of read-write performance and thermal stability. The magnetic recording layer 24 can be composed of a single layer or a plurality of layers.

The mask layer, which is not shown in FIGS. 2A through 2F, can be selected from a titanium film, a chromium film, a carbon film, and an SiOx film. A useful example is a single layer of carbon film with a thickness of 50 nm.

The above-mentioned layers of the underlayer 22, the magnetic recording layer 24, and the mask layer can be laminated sequentially on the nonmagnetic substrate 20 by means of a sputtering method, a CVD (chemical vapor deposition) method, or a plating method. The conditions in the process of laminating these layers can be selected from those in any known technologies. The magnetic recording layer in particular, is preferably formed by means of a sputtering method in opposing target configuration, from a viewpoint of uniformity in a film thickness, a composition, and a grain size over the whole substrate surface.

Before applying a resist material on the laminated body formed of the underlayer 22, the magnetic recording layer 24, and the mask layer deposited on the nonmagnetic substrate 20, magnetization directions in the magnetic recording layer 24 are aligned in one direction. Specifically, the magnetization orientation is aligned uniformly in one direction perpendicular to the front and back surfaces of the laminated body by applying a magnetic field by two magnets approaching the front and back surfaces of the laminated body from above and below in the vertical direction in FIG. 1.

After that, a resist material is applied. A useful resist material can be OCNL505, a product of Tokyo Ohka Kogyo Co., Ltd., for example, which favorably allows imprinting at the room temperature and exhibits high resistance to etching in processing the magnetic recording layer 24. In a case of thermal imprinting, another resist of a thermoplastic resin can be used as well.

A thickness of the applied resist material 26 is preferably different in the region D and in the region S. An application thickness in the region D is varied depending on the pattern height and duty ratio of the stamper 28, and preferably in the range of 10 to 100 nm in view of balance between pattern height and remained film after forming an imprinted pattern. In the region S, on the other hand, a resist material is not necessarily applied as shown in FIG. 2A. Nevertheless, a resist material not thicker than 60 nm can be applied to leave only a thin film. The resist material 26 can be applied by means of an ink jet technique. The regions D and the regions S are generally arranged alternately and periodically in the circumferential direction of the medium. The regions S are arranged extending in a shape of a bow in the radial direction of the medium.

(2-1-2. Forming a Stamper)

A stamper 28 is constructed with a pattern of protrusions and recesses, in which at least protruding parts of the pattern are composed of a soft magnetic material since high permeability is necessary for concentrating magnetic flux at the protruding parts of the pattern. The whole stamper can be made of a soft magnetic material. Alternatively, a stamper can comprise an adhesion layer and a soft magnetic layer formed on a nonmagnetic substrate, and solely protruding parts on the surface region are composed of a soft magnetic material.

A stamper entirely composed of a soft magnetic material can be produced by an electroforming technique utilizing a resist pattern fabricated by electron beam lithography. The soft magnetic material can be selected from nickel, cobalt, FeCo and alloys of these substances.

On the other hand, a stamper in which solely the protruding parts on a nonmagnetic substrate are composed of a soft magnetic material can be formed in the following way. An adhesion layer, a soft magnetic layer, and a mask layer are successively formed on a nonmagnetic substrate by a sputtering method. The nonmagnetic substrate can be made of glass, silicon, or resin. The adhesion layer can be made of titanium, chromium, or an alloy of these elements. The soft magnetic layer can be composed of cobalt, FeCo, or the like. The mask layer, which is used for a mask in a process of etching the soft magnetic layer, can be a chromium film, a carbon film, an SiO2 film, a titanium film, or the like.

The etching process can be conducted using a mask layer of a laminated film consisting of or including a carbon film with a thickness of 5 to 300 nm and a chromium film with a thickness of 1 to 300 nm. Specifically, a laminated body is prepared by depositing an adhesion layer, a soft magnetic layer, and a mask layer (consisting of or including a carbon film and a chromium film) on a nonmagnetic substrate. A resist material for electron beam lithography is applied on the laminated body to a thickness of 10 to 500 nm. Then, electron lithography is conducted in a predetermined pattern. Utilizing the resist pattern produced by the electron beam lithography, a process of etching the chromium film is conducted by argon milling. Subsequently, the carbon film is etched utilizing the chromium film by reactive ion etching process using oxygen gas. After that, the soft magnetic layer is etched by argon milling utilizing the chromium film and the carbon film. Finally, the carbon film is removed by a reactive ion etching process using oxygen gas.

A height of the pattern of soft magnetic layer is favorably high from the view point of ease of magnetic flux concentration on the one hand; and it needs to be low from the view point of pattern formation on the other hand. Thus, an optimum height exists. A width of a groove in the pattern is preferably in the range of 10 to 300 nm from the view point of enhancing recording density of a magnetic recording medium. A height of the pattern is preferably in the range of 10 to 300 nm from the view points of magnetic flux concentration and mechanical strength of the protrusions and recesses.

Thus, a fabricated pattern of a stamper can have dimensions, in a sectional view, of a pitch in a width direction of 100 nm, a horizontal width of a protruding part of 30 nm, a horizontal width of a recessed part of 70 nm, and a pattern height of 60 nm, for example.

[2-2. Step (b) of Pressing the Resist by a Stamper]

FIG. 2B is a sectional view showing a step of pressing the resist 26 by a stamper 28. This step conducts an imprinting process to transfer the pattern of protrusions and recesses of the stamper 28 onto the resist material 26.

The laminated body with the resist material applied on the specified place obtained in the step shown in FIG. 2A is set on a jig for a nano-imprinting process. The stamper 28 is set at a specified place of the jig opposing the laminated body while confirming the pattern in the region of applied resist material using a CCD (a charge-coupled device). Then, the stamper 28 is pushed to the laminated body with a pressure of 10 to 250 MPa in an atmosphere of the room temperature and normal pressure. This state is maintained for a period not longer than 10 min.

After pressing with the stamper 28, the pressure is released, and the laminated body and the stamper 28 in their adhered state are withdrawn from the jig. Thus, the pattern of protrusions and recesses on the stamper 28 is transferred onto the resist layer 26.

[2-3. Step (c) of Applying a Magnetic Field to the Resist Layer and the Stamper in their Adhered State]

FIG. 2C is a sectional view showing a step of applying a magnetic field to the resist layer 26 and the stamper 28 in their adhered state. In this step, the pattern of protrusions and recesses of the stamper 28 is magnetically transferred to mainly the region S of the magnetic recording layer 24 of the laminated body.

The laminated body and the stamper 28, withdrawn from the jig for the nano imprinting process in their adhered state as shown in FIG. 2B, is set on a jig for a magnetic transfer process. In this state, a magnetic field is applied perpendicularly to the surface of the laminated body. More specifically, a pair of permanent magnets is disposed above and below the laminated body opposing to and in the close vicinity of the laminated body. A magnetic field is applied through the laminated body in this state. The application of the magnetic field is preferably conducted under a condition of the magnets disposed in the vicinity of the laminated body with a gap in the range of 0.1 to 5 mm from the view point of magnetic inversion solely in the necessary places.

After the magnetic field application, the laminated body and the stamper 28 are separated from each other. In this step, shown in FIG. 2C, the pattern of protrusions and recesses of the stamper 28 is magnetically transferred to mainly the region S of the magnetic recording layer 24 of the laminated body, while maintaining a specified configuration on the laminated body formed in the step of FIG. 2B.

[2-4. Step (d) of Forming a Resist Layer in a Region to Form a Servo Region]

FIG. 2D is a sectional view showing a step of forming a resist layer 30 in the region S. In this step as shown in FIG. 2D, a resist material is applied in the region S in which magnetic transfer has been conducted in the step of FIG. 2C.

Useful resist material in this step can be OCNL505, a product of Tokyo Ohka Kogyo Co., Ltd., for example. It is preferable to use the same resist material as the one used for applying in the region D in the step of FIG. 2A from the view point of searching a condition for an etching process and stability in the process of removing the resist material. The resist material is applied by an ink jet technique solely in the region S avoiding the region D in which a pattern of protrusions and recesses have been already formed. A thickness of application in the region S in this step is preferably in the range of 10 to 100 nm from the view point of maintaining magnetic characteristics in the region S in a subsequent etching process and ease of removing the resist layer.

[2-5. Step (e) of Etching]

FIG. 2E is a sectional view showing an etching step. In this step, remained resist film in the region D is removed by a dry etching process. According to the resist pattern from which the remained film has been eliminated, the magnetic recording layer 24 is etched. In the region S, the etching is not performed since the resist material has been applied with a sufficient thickness in step (d).

The remained resist film at the recessed parts in the region D is removed by a dry etching method. More specifically, by means of a reactive ion etching process using CF4 gas and based on the study result on the separately measured etching rate, the resist layer is etched by 2 to 50 nm, to expose the mask layer at the bottom of the recessed part eliminating the resist layer.

Then, the mask layer is removed by means of a reactive ion etching process using oxygen gas and based on the study result on the separately measured etching rate, the mask layer being etched by 10 to 100 nm, to expose the magnetic recording layer 24 at the bottom of the recessed part eliminating the mask layer.

Subsequently, the magnetic recording layer 24 exposed at the recessed parts in the region D is etched by a milling process using argon gas and based on the study result on the separately measured etching rate, the magnetic recording layer being etched by 5 to 100 nm, to eliminate the magnetic recording layer 24.

Since a sufficiently thick resist material has been applied in the region S in step (d), the mask layer remains after etching the magnetic recording 24 at the recessed parts in the region D, leaving the magnetic recording layer 24 not etched in the region S.

The example described above for etching a magnetic recording layer 24 conducts the etching by a milling process using argon gas. This means can be replaced by a means for obliterating the magnetism of the magnetic recording layer 24 performed by ion implantation.

[2-6. Step (f) of Removing the Resist Film]

FIG. 2F is a sectional view showing a step of removing the resist film and other material. In this step, the resist film remained on the magnetic recording layer 24 is removed, and further, the mask layer is eliminated as well.

The remained resist film is removed by a reactive ion etching process using CF4 gas. The mask layer is removed by a reactive ion etching process using oxygen gas. If the removal of the mask layer is insufficient, the mask layer remains on the pattern in the region D or in the region S, making the gap between the driving head and the magnetic recording layer 24 excessively large. Thus, good signal characteristics cannot be obtained in the driving operation. If the removal of the mask layer is excessive, magnetic characteristics of the magnetic recording layer 24 degrade, failing to provide good signal characteristics in the driving operation in this case, too.

After removal of the mask layer, as required, it is preferable to remove a damaged layer generated in the magnetic recording layer 24 by conducting a light etching process by means of an argon milling process.

The mask layer can be removed by an amount corresponding to a remained thickness by preliminarily measuring the thickness of the remained mask layer using an atomic force microscope (AFM) and utilizing a study result on the etching rate of the mask layer. After that, the damaged layer can be removed by a thickness of 0.1 to 20 nm in the surface region by a light etching process by means of an argon milling process.

In the method of manufacturing a magnetic recording medium according to the present invention as described thus far, pattern formation is executed by specified steps on both the data region and the servo region using a single stamper. The method provides, firstly, easy recording of the servo information. The manufacturing method, secondly, prevents mismatching at the boundary between the data region and the servo region. Consequently, positioning of the magnetic head is conducted favorably in the manner suited to the specified data region according to the servo information recorded in the servo region in the process of writing on the data region of the magnetic recording medium.

### EXAMPLES

Effects of the present invention will be clarified by the following specific embodiment examples. The following examples are in accordance with the aspect of embodiment described above and FIGS. 2A through 2F. So, some items described above are omitted in the following description.

<Manufacturing a Magnetic Recording Medium>

A resist film was formed in the region D as shown in FIG. 2A. A nonmagnetic substrate 20 used was a strengthened glass substrate with a dimensions of an outer diameter of 65 mm, an inner diameter of 20 mm, and a thickness of 0.635 mm. On the substrate 20, a magnetic recording layer 24 of a CoPt film 20 nm thick was formed and a mask layer of a carbon film 50 nm thick was formed. The magnetization direction of the magnetic recording layer 24 was aligned in one direction prior to formation of a resist layer 26. Then, a resist layer of OCNL505 manufactured by Tokyo Ohka Kogyo Co., Ltd. was formed with a thickness of 40 nm solely in the region D avoiding the region S by means of an ink jet technique. Thus, a structure as shown in FIG. 2A was obtained consisting of or including a laminated body with a resist material applied thereon.

Separately from the above-mentioned structure, a stamper was fabricated as follows. On a nonmagnetic substrate of silicon successively formed were: an adhesion layer of a CrTi alloy 5 nm thick, a soft magnetic material layer of a CoFe alloy 60 nm thick, and a mask layer consisting of a carbon film 100 nm thick and a chromium film 10 nm thick. After applying a resist material to a thickness of 60 nm followed by electron beam lithography, an etching process for the carbon film and the chromium film was conducted. Thus, a stamper was obtained having a pattern with dimensions of a pitch in the width direction of 100 nm, a horizontal width of the protruding parts of 30 nm, a horizontal width of the recessed parts of 70 nm, and a height of the pattern of 60 nm.

The resist material was pressed by the stamper as shown in FIG. 2B. The stamper 28 was pushed against the structure in the conditions of an atmosphere at a room temperature and normal pressure, a pressure of 100 MPa, and for a pressing time of 1 min.

Then as shown in FIG. 2C, a magnetic field was applied to the magnetic recording layer 24 in the state adhered to the stamper. A pair of permanent magnets was disposed above and below the laminated body opposing to and in the close vicinity of the laminated body with a gap of 1 mm. In this state, the resist pattern in the region D was measured by an atomic force microscope (AFM), which confirmed the dimensions in the structure of FIG. 2C of a pitch in the width direction of 100 nm, a horizontal width of the protruding parts of 70 nm, a horizontal width of the recessed parts of 30 nm, and a pattern height of 50 nm.

Then as shown in FIG. 2D, a resist layer was formed in the region S. A resist material, OCNL500 manufactured by Tokyo Ohka Kogyo Co., Ltd., was applied by an ink jet technique solely in the region S avoiding the region D, to a thickness of 60 nm.

Then as shown in FIG. 2E, an etching process was conducted on the recessed parts in the region D. The resist film was first etched by a depth of 5 nm to expose the carbon film, and subsequently the carbon film was etched by 50 nm to expose the magnetic recording layer 24, and finally the magnetic recording layer 24 was etched by 20 nm. As for the region S, owing to the remained carbon film, the magnetic recording layer 24 was not etched.

Then as shown in FIG. 2F, the resist layer and other materials were removed. The remained resist film was removed by a reactive ion etching process. Subsequently, the mask layer was removed by an amount corresponding to the remained thickness by means of a reactive ion etching method. Finally, a damaged layer was removed by a light etching process on the surface region with a thickness of 0.1 nm by means of an argon milling process. Thus, a magnetic recording medium as shown in FIG. 2F was obtained.

<Evaluation of the Magnetic Recording Medium>

The thus-manufactured magnetic recording medium was observed by an AFM and a magnetic force microscope (MFM). The observations confirmed that a pattern of dots separated with grooves was formed with a pitch of 100 nm in the data region of the magnetic recording layer.

In the servo region, it has been confirmed that magnetic information was written consisting of or including magnetization of up and down directions of N/S on a flat region.

The magnetic recording medium was further evaluated by a glide height test in which a seeking operation was executed using a test head by driving the head from the inner circumference to the outer circumference while rotating the medium to measure variation of the flying height over the whole surface of the medium. It has been confirmed that the head flying performance was stable with little variation of flying height.

In addition, a signal pattern and a signal intensity were evaluated by maintaining the head on-track by eccentricity correction and servo following using a read/write tester and detecting the servo signal. Through the evaluation, a satisfactory servo signal has been confirmed. Similarly, a read/write test was conducted in the data region in the state of on-track carried out by the reread/write tester, confirming satisfactory read/write signal performance also in the data region.

A magnetic recording medium according to the present invention does not need a separate process of writing servo information afterwards. A method of manufacturing a magnetic recording medium according to the present invention allows servo information to be readily recorded. Further, a manufacturing method of the invention prevents mismatching at the boundary between the data region and the servo region, and thus, positioning of the magnetic head is conducted favorably in the manner suited to the specified data region. Therefore, a magnetic recording medium and method of the invention are promising because they provide, with ease and high accuracy, a recording medium in which ever improving magnetic performances are demanded.

It will be apparent to one skilled in the art that the manner of making and using the claimed invention has been adequately disclosed in the above-written description of the exemplary embodiments taken together with the drawings. Furthermore, the foregoing description of the embodiments according to the invention is provided for illustration only, and not for limiting the invention as defined by the appended claims and their equivalents.

It will be understood that the above description of the exemplary embodiments of the invention are susceptible to various modifications, changes and adaptations, and the same are intended to be comprehended within the meaning and range of equivalents of the appended claims.

What is claimed is:

1. A magnetic recording medium comprising a data region for recording data and a servo region that is disposed adjacent to the data region and has recorded information for controlling a magnetic head, the data region having a pattern of dots separated by grooves or nonmagnetic material from each other, and the servo region lacking the pattern of dots and including magnetic information written in a flat region.

2. A method of manufacturing a magnetic recording medium comprising steps of:
forming a resist layer at least in a region to form a data region of a magnetic recording layer formed on a nonmagnetic substrate;
forming a pattern of resist by pressing the resist layer by a stamper having a fine pattern of protrusions and recesses formed thereon; and
applying a magnetic field in a thickness direction of the magnetic recording layer while maintaining an adhered state of the resist layer and the stamper to transfer magnetic information according to the pattern of protrusions and recesses on the stamper to the magnetic recording layer.

3. The method of manufacturing a magnetic recording medium according to claim 2 further comprising steps of:
forming a resist layer in a region to form the servo region on the magnetic recording layer;
forming a plurality of grooves or a plurality of nonmagnetized regions in the region to form the data region of the magnetic recording layer to form a pattern of dots separated by the grooves or the nonmagnetized regions; and
removing the resist layer remained in the data region and the servo region.

4. The method of manufacturing a magnetic recording medium according to claim 2, further comprising a step of forming an underlayer between the nonmagnetic substrate and the magnetic recording layer.

5. The method of manufacturing a magnetic recording medium according to claim 3, further comprising a step of forming an underlayer between the nonmagnetic substrate and the magnetic recording layer.

6. A method comprising:
forming a magnetic recording layer on a nonmagnetic substrate, the magnetic recording layer including an area corresponding to a data region and an area corresponding to a servo region;
forming a resist layer on the area corresponding to the data region;
transferring a pattern of protrusions and recesses corresponding to the data region to the resist layer, by pressure applied with an imprinting device to both the area corresponding to the data region and to the area corresponding to the servo region; and
while the imprinting device and the resist layer are in an adhered state, applying a magnetic field to transfer magnetic information according to the pattern of protrusions and recesses, and to the servo region, to the magnetic recording layer.

7. The method of claim 6, further comprising:
forming a resist layer on the area corresponding to the servo region; and
etching to remove a remaining portion of the resist layer formed on the area corresponding to the data region.

8. A magnetic recording medium comprising:
a data region for recording data; and
a servo region adjacent to the data region;
wherein
the data region includes a pattern of protrusions and recesses, and
the servo region includes magnetic information in a flat region at least partly characterized by an absence of the pattern of protrusions and recesses, the magnetic information including control information for controlling a magnetic head.
